(19) United States
(12) Patent Application Publication
(10) Pub. No.: US 2020/0131993 A1
(43) Pub. Date: Apr. 30, 2020

(54) METHOD FOR IMPROVING THE PERFORMANCE OF A GAS TURBINE

(71) Applicant: Siemens Aktiengesellschaft, Munich (DE)

(72) Inventors: Rick Giesel, Essen (DE); Jannik Lüpfert, Essen (ES); Bernd Vonnemann, Gladbeck (DE)

(73) Assignee: Siemens Aktiengesellschaft, Munich (DE)

(21) Appl. No.: 16/628,667

(22) PCT Filed: Jun. 27, 2018
(86) PCT No.: PCT/EP2018/067190

§ 371 Date: Jan. 4, 2020

(30) Foreign Application Priority Data
Jul. 21, 2017 (DE) 10 2017 212 575.6

(51) Int. Cl. F02C 7/18

(52) U.S. Cl. CPC F02C 7/18; F05D 2260/201; F05D 2230/10

(57) ABSTRACT

A method for improving the performance of a gas turbine, in which a hub annually surrounding a rotor is machined when the rotor is in the non-stacked state and hot shield elements that are arranged on the hub are exchanged. The method includes a) dismantling of the rotor together with the surrounding hub from the gas turbine; b) horizontal mounting of the rotor in the non-destacked state; c) removing of all heat shield elements of the row which is arranged as the last row in the flow downstream direction; d) mechanical machining, in particular complete removing of the hub projection; e) machining of at least some of the existing cooling air bores and/or producing of new cooling air bores, and f) mounting of new heat shield elements, the design of which differs from that of the heat shield elements which were removed in step c).

### CROSS REFERENCE TO RELATED APPLICATIONS

This application is the US National Stage of International Application No. PCT/EP2018/067190 filed 27 Jun. 2018, and claims the benefit thereof. The International Application claims the benefit of German Application No. DE 10 2017 212 575.6 filed 21 Jul. 2017. All of the applications are incorporated by reference herein in their entirety.

### FIELD OF INVENTION

The invention relates to a method for increasing the performance of a gas turbine which has a combustion chamber, a rotor which comprises a shaft and a plurality of turbine rotor blade rows which are arranged in an axially adjacent manner on the shaft, and a hub which is arranged upstream of the turbine rotor blade rows, extends around the shaft, is of funnel-like configuration, and to which a plurality of rows of heat shield elements are fastened in an axially adjacent manner, which heat shield elements cover a large part of the radially outwardly pointing face of the hub in an insulating manner and define a part of a boundary of the combustion chamber, the heat shield elements of the row which is arranged as the last row in a flow downstream direction being arranged adjacently with respect to a radially outwardly projecting hub projection of circumferential configuration, and being cooled via cooling air bores which are configured in the hub.

### BACKGROUND OF INVENTION

Gas turbines of the type mentioned at the outset are already known in the prior art. Reference is to be made by way of example at this point to the gas turbine type SGTS-4000F from Siemens AG.

In order to increase the performance of gas turbines of this type, it is known, furthermore, to modify individual components of the gas turbine. Modifications of this type are aimed at optimizing the flow of the hot gas through the turbine, at reducing the cooling fluid mass flow which is required for the operation of the gas turbine, etc. If components of the rotor and/or the hub are affected by the modifications, it is usually necessary to dismantle the rotor and to destack it completely, in order for it to be possible for work to be carried out on the shaft, on the components which are held on the latter, or on the hub. Destacking of this type of the rotor is associated, however, with very high complexity and is accordingly not desirable.

### SUMMARY OF INVENTION

Proceeding from said prior art, it is an object of the present invention to provide a method of the type mentioned at the outset, with the aid of which the performance of the gas turbine can be increased with comparatively low complexity.

In order to achieve said object, the present invention provides a method of the type mentioned at the outset which has the steps: a) dismantling of the rotor together with the hub which surrounds it from the gas turbine; b) horizontal mounting of the rotor in the non-destacked state, in particular on suitable bearing blocks; c) removing of all heat shield elements of the row which is arranged as the last row in the flow downstream direction; d) mechanical machining, in particular complete removing of the hub projection; e) machining of at least some of the existing cooling air bores and/or producing of new cooling air bores, and f) mounting of new heat shield elements, the design of which differs from that of the heat shield elements which were removed in step c).

The invention is based on the fundamental concept of replacing the heat shield elements of the row which is arranged as the last row in the flow downstream direction, that is to say those heat shield elements which are positioned immediately adjacently with respect to the turbine, with heat shield elements with an optimized design, in order for it to be possible in this way for an improved insulation effect to be achieved and for the cooling fluid mass flow which is required for said heat shield element row to be reduced accordingly. For this purpose, the rotor is dismantled together with the hub which surrounds it from the gas turbine in a first step, and is mounted horizontally in the non-destacked state. Suitable bearing blocks, on which the rotor is arranged, can be used for mounting purposes, for example. In a further step, all heat shield elements of the row which is arranged as the last row in the flow downstream direction are removed in said state, as a result of which the adjoining hub projection is also exposed and is correspondingly readily accessible. Subsequently, the hub projection is machined within the context of one or more mechanical machining steps in the non-destacked and mounted state, that is to say is reduced in size or is removed completely, to which end the hub can first of all be fixed relative to the rotor. Furthermore, machining of at least some of the existing cooling air bores takes place, the aim of which machining is to reduce the overall opening cross-sectional area of the cooling air bores which are provided for cooling the heat shield elements of the last row, in order to reduce the cooling fluid mass flow which flows through said cooling air bores during the operation of the gas turbine and accordingly to optimize the performance of the gas turbine. Within the context of the machining, new cooling air bores can also be made, as long as the overall opening cross-sectional area of the cooling air bores after the machining is smaller than the overall opening cross-sectional area of the cooling air bores which existed before the machining. In a subsequent step, new heat shield elements are mounted, the design of which differs from that of the heat shield elements which were removed in step c), in particular in such a way that the insulation effect which is associated with the heat shield elements is improved, by the new heat shield elements assuming the shielding function of the removed hub projection during the operation of the gas turbine. The method according to the invention is distinguished not only by way of the performance increase of the gas turbine, which performance increase accompanies said method, but rather also by way of the comparatively low complexity which accompanies the performance of the method. The latter is due, in particular, to the fact that destacking of the rotor is dispensed with within the context of the method according to the invention.

The mechanical machining in step c) advantageously comprises a turning process. In this way, the hub projection can be modified in accordance with the requirements quickly and without problems or can be removed.

In accordance with one refinement of the method according to the invention, in order to carry out the turning process, a mobile turning machine is used which has an annular carrier which is arranged and oriented concentrically with respect to the rotor, and a turning tool which can be moved along the carrier circumferentially and along a plurality of axes. Accordingly, the shaft of the horizontally mounted and non-destacked rotor can be machined on site in a plurality of axes. Here, in particular, the controller of the turning machine is designed to compensate for radial and axial deviations of the orientation of the rotor and the carrier.

The carrier is advantageously configured in such a way and is arranged in such a way that it is supported mainly on the underlying surface, for example on a hall floor, and not on the rotor to be machined itself, as a result of which loading of the rotor by way of the weight of the turning machine during machining of the hub is prevented. To this end, the carrier of the turning machine is supported on the underlying surface via supporting elements, in particular.

In order to reduce the cooling fluid mass flow, in step e), at least one existing cooling air bore which has, in particular, a diameter of 4 mm or less is advantageously calked, in order to close it completely or partially. The calked cooling air bore can then be drilled out again in order to produce a new cooling air bore, the diameter of the new cooling air bore being smaller than the diameter of the original or calked existing cooling air bore.

As an alternative or in addition, in step e), at least one existing cooling air bore which has, in particular, a diameter of more than 4 mm, can be drilled out at least partially to a greater diameter, can be provided with a thread, and can be subsequently closed by way of a threaded plug, it being possible for the threaded plug to be provided with a through hole, the diameter of which is smaller than 4 mm and, in particular, lies in the range from 1.5 to 2.5 mm. This procedure can be used to close or reduce the size of existing cooling air bores with diameters of a magnitude which cannot be readily calked, which is the case according to experience in the case of diameters which are more than 4 mm.

A wax wedge is advantageously inserted into the at least one existing cooling air bore before it is drilled out. It can be prevented in this way that, during the drilling out operation, chips fall through the cooling air bore into the interior of the non-destacked rotor, where they can be removed only with difficulty.

In accordance with one refinement of the present invention, in step e), new cooling air bores are produced with the use of a prefabricated drilling template. In this way, desired positioning of the bores can be ensured in a simple way.

The heat shield elements which are newly mounted in step f) advantageously have, on the edge side, a radially inwardly projecting, in particular ring segment-shaped projection which is arranged so as to point in the flow downstream direction and accordingly assumes the shielding function of the hub shoulder which has previously been removed.

### BRIEF DESCRIPTION OF THE DRAWINGS

Further features and advantages of the method according to the invention will become clear on the basis of the following description of one embodiment of a method according to the invention with reference to the appended drawing, in which:

FIG. 1 shows a diagrammatic sectional view of a region of a gas turbine,

FIG. 2 shows an enlarged perspective view of the detail which is denoted by way of the designation II in FIG. 1,

FIG. 3 shows a side view of a hub of the gas turbine which is shown in FIG. 1, a heat shield element of the heat shield element row which is arranged as the last row in a flow downstream direction being removed for illustrative purposes,

FIG. 4 shows an enlarged view of the detail which is labeled by way of the designation IV in FIG. 3,

FIG. 5 shows an enlarged view of the detail which is labeled by way of the designation V in FIG. 4 and shows a part region of a cooling air bore pattern of the hub,

FIG. 6 shows a perspective diagrammatic view of a rotor of the gas turbine which is shown in FIG. 1, during machining of the hub, the rotor being situated in the dismantled and propped state,

FIG. 7 shows a view which is analogous to FIG. 4 after the machining according to FIG. 5 has been carried out,

FIG. 8 shows an enlarged view of the detail which is labeled by way of the designation VIII in FIG. 7, which corresponds to the detail which is shown in FIG. 5, and is provided with a new cooling air bore pattern,

FIG. 9 shows a sectional view which shows a cooling air bore which is shown in FIG. 7, and

FIG. 10 shows a view which is analogous to FIG. 2 and shows the corresponding region with newly mounted heat shield elements, the design of which differs from the design of the heat shield elements according to FIG. 2.

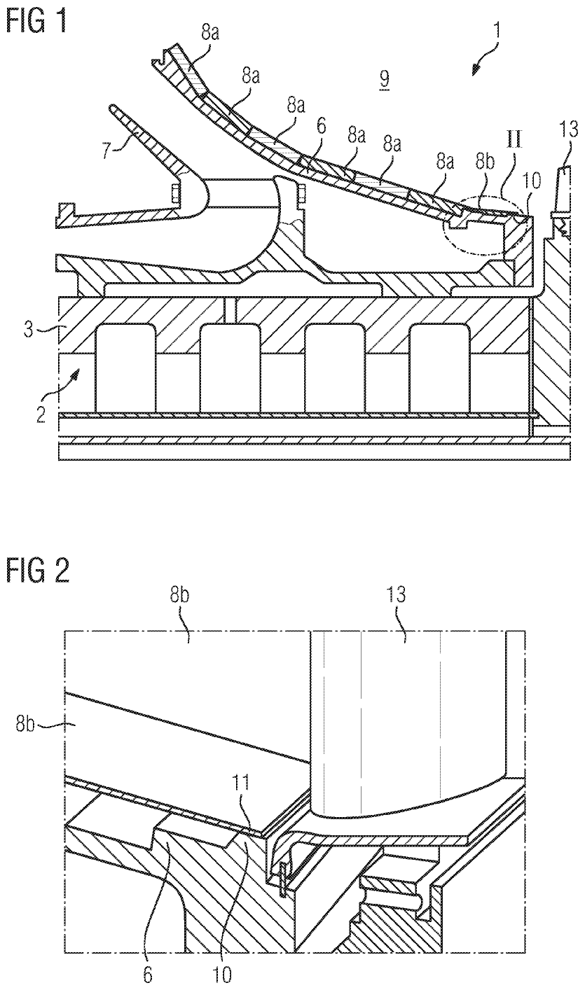

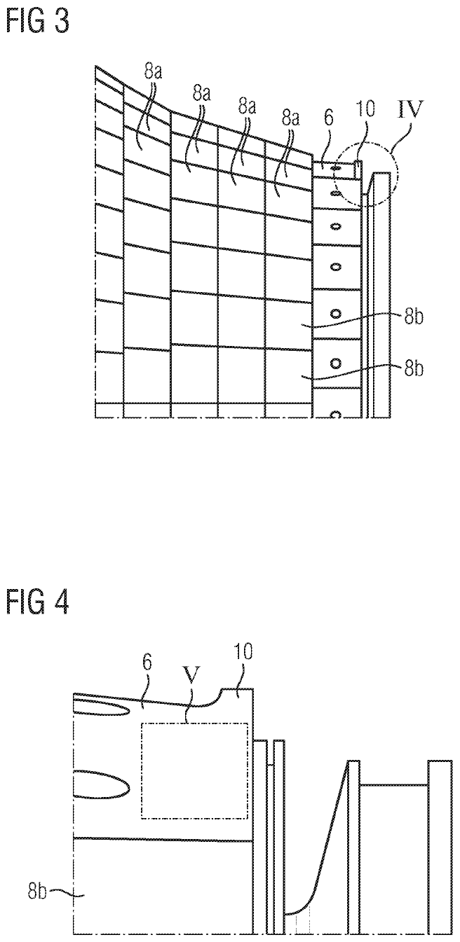

### DETAILED DESCRIPTION OF INVENTION

In the following text, identical designations relate to identical or similar components.

The gas turbine 1 comprises a rotor 2 with a shaft 3, on which both a plurality of axially adjacently arranged turbine rotor blade rows 4 of a turbine region and a plurality of adjacently arranged compressor rotor blade rows 5 of a compressor region of the gas turbine 1 are arranged and fastened. Furthermore, the gas turbine 1 comprises a hub 6 which extends around the shaft 3, is of funnel-like configuration, is arranged between the turbine region and the compressor region, and tapers in diameter in the direction of the turbine rotor blade rows 4 and therefore in a flow downstream direction. The hub 6 is oriented concentrically with respect to the shaft 3, leaving a radial annular gap, and is held in a stationary manner on a housing 7 of the gas turbine 1, with the result that it does not rotate with the shaft 3. A plurality of annular rows of heat shield elements 8a, 8b are fastened in an axially adjacent manner to the outer side of the hub 6, which heat shield elements 8a, 8b cover the radially outwardly pointing face of the hub 6 in an insulating manner and define the inner part of the boundary of a combustion chamber 9 of the gas turbine which extends in an annular manner around the shaft 3. The radially outer boundary of the combustion chamber 9 is likewise brought about via heat shield elements which are not shown in greater detail and are fastened to the combustion chamber outer shell. In the present case, the heat shield elements 8b of the heat shield element row 4 which is arranged as the last row in the downstream direction differ with regard to their design from the heat shield elements 8a of the remaining heat shield element rows, are arranged adjacently with respect to a radially outwardly projecting hub projection 10 of circumferential configuration, and overlap the latter with an axially outwardly pointing projection 11. During the operation of the gas turbine 1, the heat shield elements 8 are cooled with the use of cooling air which is fed in via cooling air bores 12 which are configured in the hub 6. In the present case, as shown in FIG. 5, the cooling air bores 12 which are provided for cooling the heat shield elements 8b are arranged in a regular matrix such that they are spaced apart from one another uniformly, and extend in each case perpendicularly with respect to the outer face of the hub 6.

During the operation of the gas turbine 1, ambient air which is compressed in the compressor region of the gas turbine 1 is mixed with a fuel, the fuel/air mixture which is produced is burned in the combustion chamber 9 and is guided to the turbine region of the gas turbine 1, where the hot gas is steered in a favorable way in terms of the flow via corresponding guide blade rows 13 to the respective adjacent turbine rotor blade rows 4, with the result that the rotor 2 is driven rotationally in a known way. Part of the compressed air flow which is produced in the compressor region of the gas turbine 1 is used for cooling the heat shield elements.

In order to increase the performance of the gas turbine 1, the following steps are carried out in the case of a method in accordance with one embodiment of the present invention:

In a first step, the rotor 2 together with the hub 6 which surrounds it is dismantled from the gas turbine 1. Subsequently, the dismantled rotor 2 is mounted horizontally in the non-destacked state, which takes place with the use of corresponding bearing blocks 14, as shown in FIG. 5.

Afterward, in a further step, at least all the heat shield elements 8b of the turbine rotor blade row 4 which is arranged as the last row in the flow downstream direction are removed, in order to expose the hub 6 in said region.

In a subsequent step, a mobile turning machine 15 is erected in the region of the horizontally mounted rotor 2. The mobile turning machine comprises an annular carrier 16 which is arranged and oriented concentrically with respect to the propped rotor 2, and a turning tool 17 which can be moved circumferentially along the carrier 16 and can be advanced in the X-direction, the Y-direction and the Z-direction. The carrier 16 is supported on the hub 6 via extendable cylinders 18a. In addition, in the present case, the carrier 16 is supported on the underlying surface 19 via two supporting elements 18. In this way, loading of the hub 6 by way of the weight of the carrier 16 of the turning machine 15 is prevented.

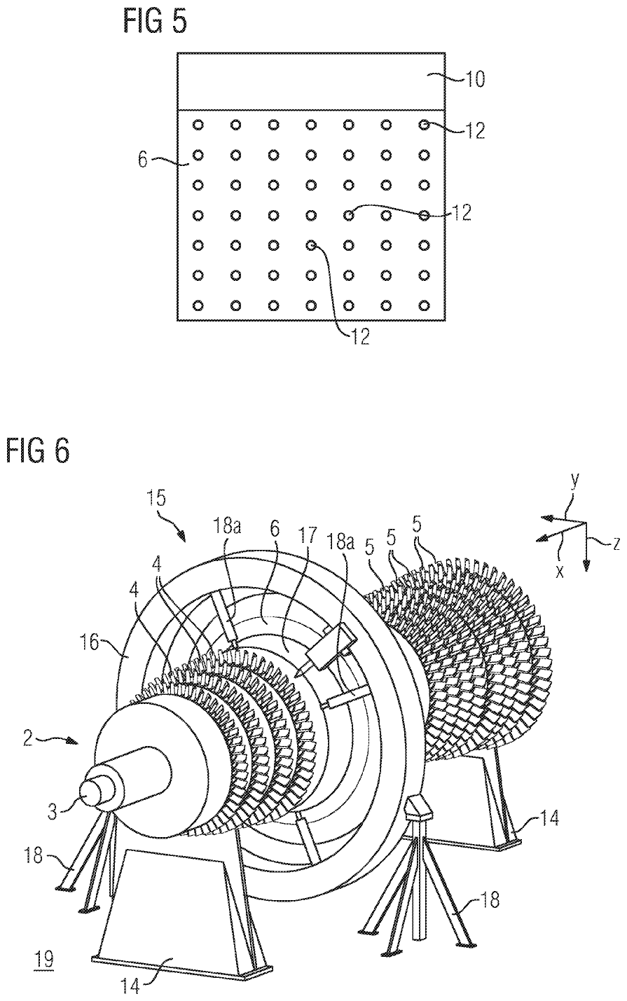

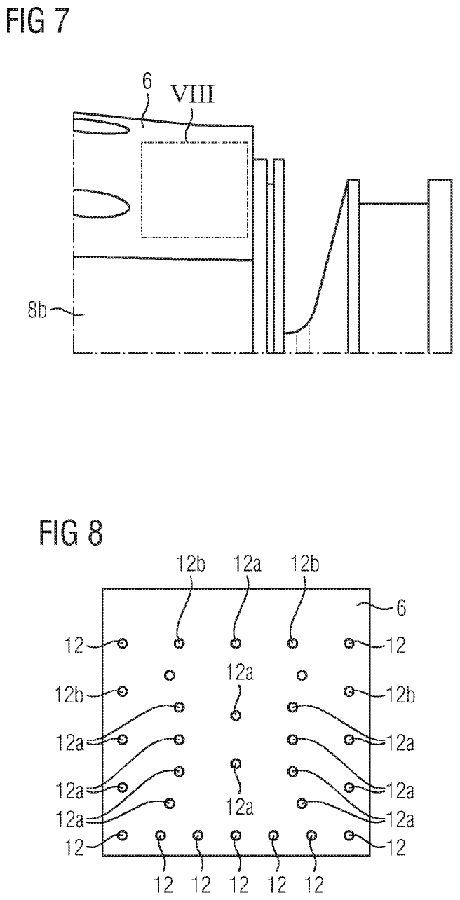

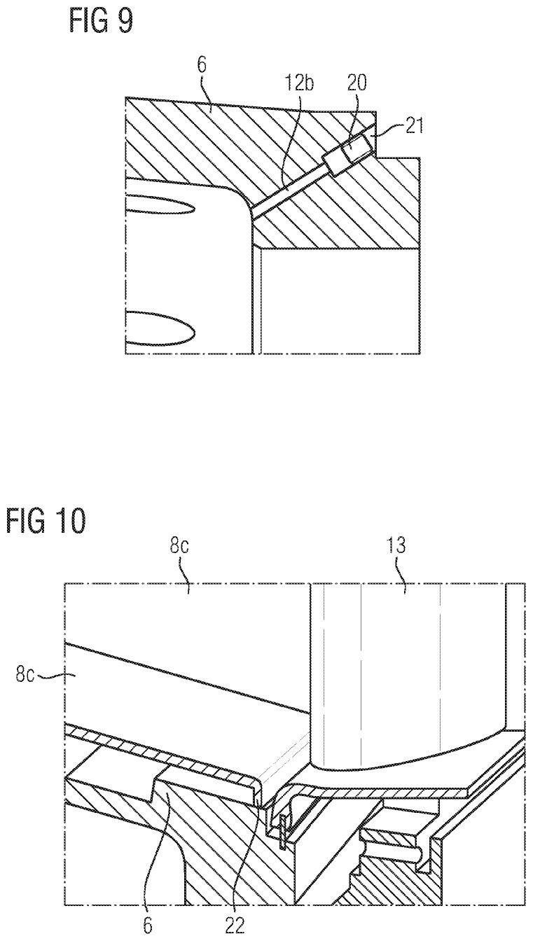

The hub projection 11 is then removed mechanically completely within the context of turning machining with the use of the turning machine 15 which is shown highly diagrammatically in FIG. 6. Here, the controller of the turning machine 15 is advantageously designed in such a way that, in the case of the machining, radial and axial deviations of the orientation of the hub projection 11 and the carrier 16 are compensated for. Reference is to be made in this context to the application DE 102016219193.4, to the full scope of the contents of which reference is hereby made. Further mechanical machining steps can follow.

In a further step, at least some of the existing cooling air bores 12 are machined and, in the present case, new cooling air bores are also produced. Said machining step aims to reduce the overall opening cross-sectional area of the cooling air bores which are used for cooling the heat shield elements 8b of the last turbine rotor blade row 4, in order to reduce the cooling fluid mass flow which flows through said cooling air bores during the operation of the gas turbine 1, and accordingly to optimize the performance of the gas turbine 1. In the present case, within the scope of said cooling air bore machining, at least some of the existing cooling air bores 12 which have a diameter of 4 mm or less are calked, in order to close them completely. Calked cooling air bores of this type can be seen on the basis of a comparison of FIGS. 5 and 8. These are those cooling air bores 12 from FIG. 5 which are no longer present in FIG. 8. Furthermore, within the context of the cooling air bore machining, new air bores 12a are drilled, the diameters of which advantageously lie in the range from 1.5 to 2.5 mm. With regard to their position, the newly drilled cooling air bores 12a can coincide completely or partially with closed cooling air bores 12a. In other words, calked cooling air bores 12 are then drilled out again at least partially, the diameter of the new cooling air bores 12a being smaller than the diameter of the original calked cooling air bores 12. As an alternative or in addition, existing cooling air bores 12 which have a diameter of more than 4 mm and can be calked only with difficulty can also be at least partially drilled out to a larger diameter, provided with a thread and subsequently closed by way of a threaded plug 20. If a cooling air bore 12 is not to be closed completely but rather is to be merely reduced in size, the threaded plug 20 can be provided with a through hole 21, the diameter of which is smaller than 4 mm and, in particular, lies in the range from 1.5 to 2.5 mm. Before a cooling air bore 12 is drilled out, what is known as a wax wedge is advantageously inserted into the cooling air bore 12, in order to prevent it being possible for chips to fall through the hub 6 in the direction of the shaft 3, which chips can be removed again only with difficulty after the drilling operation. Furthermore, as shown in FIG. 8, new cooling air bores 12b can be produced within the context of the cooling air bore machining, which new cooling air bores 12b extend through the hub 6 obliquely in relation to the radial direction.

In the case of all drilling processes, drilling templates can be used which specify the positions of the bores to be produced and their diameters, even if this is optional. Since drilling templates are essentially known in the prior art, an illustration of an exemplary drilling template is dispensed with at this point.

In a further step, new heat shield elements 8c are then mounted which replace the old heat shield elements 8b and the design of which differs from that of the heat shield elements 8b. In the present case, the newly mounted heat shield elements 8c have, on the edge side, a radially inwardly projecting projection 22 of ring segment-shaped configuration which is arranged so as to point in the flow downstream direction and assumes the shielding function of the removed hub projection 10.

In a last step, the rotor 2 which is modified with the use of the method according to the invention is installed into the gas turbine 1 again.

One essential advantage of the above-described method consists in that the performance of the gas turbine 1 is optimized by way of the reduction of the size of the overall opening cross-sectional area of the cooling air bores which are used to cool the heat shield elements of the last turbine rotor blade row, since less cooling air is required for cooling said heat shield elements. A further advantage consists in that the rotor does not have to be destacked in order to carry out the above-described method, which entails comparatively low complexity and costs.

Although the invention has been illustrated and described more closely in detail by way of the exemplary embodiment, the invention is not restricted by way of the disclosed examples, and other variations can be derived therefrom by a person skilled in the art, without departing from the scope of protection of the invention.

1. A method for increasing the performance of a gas turbine which has a combustion chamber, a rotor which comprises a shaft and a plurality of turbine rotor blade rows which are arranged in an axially adjacent manner on the shaft, and a hub which is arranged upstream of the turbine rotor blade rows, extends around the shaft, is of funnel-like configuration, and to which a plurality of rows of heat shield elements are fastened in an axially adjacent manner, which heat shield elements cover a large part of a radially outwardly pointing face of the hub in an insulating manner and define a part of a boundary of the combustion chamber, the heat shield elements of the row which is arranged as the last row in a flow downstream direction being arranged adjacently with respect to a radially outwardly projecting hub projection of circumferential configuration, and being cooled via cooling air bores which are configured in the hub, the method comprising:
a) dismantling of the rotor together with the hub which surrounds it from the gas turbine;
b) horizontal mounting of the rotor in a non-destacked state;
c) removing of all heat shield elements of the row which is arranged as the last row in the flow downstream direction;
d) mechanical machining of the hub projection;
e) machining of at least some of the existing cooling air bores and/or producing of new cooling air bores, and
f) mounting of new heat shield elements, the design of which differs from that of the heat shield elements which were removed in step c).

2. The method as claimed in claim 1,
wherein the mechanical machining in step c) comprises a turning process.

3. The method as claimed in claim 2,
wherein, in order to carry out the turning process, a mobile turning machine is used which has an annular carrier which is arranged and oriented concentrically with respect to the rotor, and a turning tool which can be moved along the carrier circumferentially and along a plurality of axes.

4. The method as claimed in claim 3,
wherein the carrier of the turning machine is supported on an underlying surface via supporting elements.

5. The method as claimed in claim 1,
wherein, in step e), at least one existing cooling air bore is calked.

6. The method as claimed in claim 5,
wherein at least one calked existing cooling air bore is drilled out again in order to produce a new cooling air bore, the diameter of the new cooling air bore being smaller than the diameter of the calked existing cooling air bore.

7. The method as claimed in claim 1,
wherein, in step e), at least one existing cooling air bore is drilled out at least partially to a greater diameter, is provided with a thread, and is subsequently closed by way of a threaded plug, it being possible for the threaded plug to be provided with a through hole, the diameter of which is smaller than 4 mm.

8. The method as claimed in claim 7,
wherein a wax wedge is inserted into the at least one existing cooling air bore before it is drilled out.

9. The method as claimed in claim 1,
wherein, in step e), new cooling air bores are produced with the use of a prefabricated drilling template.

10. The method as claimed in claim 1,
wherein the heat shield elements which are newly mounted in step f) have, on an edge side, a radially inwardly projection which is arranged so as to point in the flow downstream direction.

11. The method as claimed in claim 1,
wherein step b) of horizontal mounting of the rotor in the non-destacked state comprises mounting on suitable bearing blocks.

12. The method as claimed in claim 1,
wherein step d) of mechanical machining comprises complete removing of the hub projection.

13. The method as claimed in claim 5,
wherein, in step e), at least one existing cooling air bore which has a diameter of 4 mm or less is calked.

14. The method as claimed in claim 7,
wherein, in step e), at least one existing cooling air bore which has a diameter of more than 4 mm is drilled out at least partially to a greater diameter.

15. The method as claimed in claim 7,
wherein the threaded plug is provided with a through hole, the diameter lies in the range from 1.5 to 2.5 mm.

16. The method as claimed in claim 10,
wherein the radially inwardly projection comprises ring segment-shaped projection.
